(19) United States
(12) Patent Application Publication
(10) Pub. No.: US 2015/0152653 A1
(43) Pub. Date: Jun. 4, 2015

(54) PLATFORM

(71) Applicant: Francis Dolan, Ballinasloe (IE)

(72) Inventor: Francis Dolan, Ballinasloe (IE)

(21) Appl. No.: 14/540,771

(22) Filed: Nov. 13, 2014

(30) Foreign Application Priority Data
Dec. 3, 2013 (GB) 1321297.2

(51) Int. Cl. E04G 1/36; E04G 1/18; B66F 11/04; E04G 5/14

(52) U.S. Cl. CPC E04G 1/36; E04G 5/14; E04G 1/18; B66F 11/04

(57) ABSTRACT

A platform comprises a frame supporting an outer annular deck and an inner annular deck. The inner annular deck comprises a plurality of deck members, each deck member comprising a deck panel mounted to a radial support member. Each support member is slidable between a first state in which the deck member extends towards the centre of said platform and a second state in which the deck member is retracted towards the periphery of said platform. The deck panels overlap each other to provide a continuous annular deck portion of varying inner diameter as the support members are displaced when moving between the first state and the second state.

This application claims priority to United Kingdom patent application number 1321297.2, filed Dec. 3, 2013, which is incorporated herein by reference in its entirety.

### FIELD

The present application relates to an adjustable diameter platform for use in for example, the maintenance or demolition of a chimney.

### BACKGROUND

In the demolition of factory and power-station chimneys which have become superfluous to requirements, the simplest method is to use explosives in a controlled manner. However, this is only possible with appropriate local conditions that allow a collapse and partial overturning of the structure. When adjacent property has to be protected from damage from the use of explosives, it is usually necessary to demolish the chimney piecemeal from the top. The long standing method of obtaining access to the top of the chimney, in order to perform piecemeal demolition, is to erect scaffolding around the chimney from ground level or alternatively to erect flying scaffolding attached to the chimney. In the use of scaffolding erected from ground level it is necessary to dismantle the scaffolding gradually from the top as the demolition work progresses. In the use of flying scaffolding it is necessary to completely dismantle the scaffolding and re-erect it at lower levels as the demolition progresses. Both methods are labour-intensive and hazardous to personnel.

In order to address the drawbacks of using scaffolding, the use of annular work platforms that can be lowered around the chimney has become common. For example, Wuxi KKLBI Suspended Platform Co., Ltd. Supplies a Cirque Suspended Working Platform Scaffold. A similar platform is also disclosed in CN2261473 and CN203008344, the disclosures of which are incorporated herein by reference in their entireties. These platforms are usually attached to the outer surface of the chimney and lowered gradually as demolition progresses.

However, such platforms are generally manufactured to a particular diameter for use on a specific chimney. Once demolition is complete, the platform cannot be easily adapted for use in demolition of another chimney of different diameter. Furthermore, chimneys are usually of conical configuration, so they have a chimney foot with a much larger diameter than the upper end of the chimney. A chimney demolition platform should fit tightly around the chimney at all points in order to provide ease of access for demolition equipment or tools. Furthermore, a tight fit helps prevent accidents such as falling debris or tools slipping between the platform and chimney under demolition. Therefore, an annular platform which fits tightly at the top of a chimney will need to be adjusted as it is lowered around the chimney. This adjustment is continuous during the lowering of the platform but there can be difficulties in adjusting the platform at height to the chimney diameter and this task can become time consuming.

Therefore the object of the present invention to provide a demolition platform that allows a sufficiently precise adaptation to various chimney diameters, and wherein the adjustment can be performed quickly and efficiently.

### SUMMARY

According to the present invention there is provided a platform comprising a frame supporting an outer annular deck and an inner annular deck, wherein the inner annular deck comprises a plurality of deck members, each deck member comprising a deck panel mounted to a radial support member, each support member being slidable between a first state in which said deck member extends towards the centre of said platform and a second state in which said deck member is retracted towards the periphery of said platform, said deck panels overlapping each other to provide a continuous annular deck portion of varying inner diameter as said support members are displaced when moving between said first state and said second state. Advantageous embodiments are claimed in the dependent claims.

### BRIEF DESCRIPTION OF THE DRAWINGS

The present application will now be described with reference to the accompanying drawings in which:

FIG. 1 is a side perspective view of a platform according to an embodiment of the present invention;

FIG. 2 is a partial perspective view of an annular deck portion of the platform of FIG. 1;

FIG. 3 is an underside perspective view of the portion of the platform of FIG. 1 as it is being lowered above a chimney;

FIG. 4 is a perspective view of the platform of FIG. 1 held in place around a chimney;

FIG. 5 is an enlarged view of a portion of the platform shown in FIG. 4;

FIG. 6 is a still further enlarged view of a portion of the platform shown in FIG. 5;

FIG. 7a is a plan view of a central portion of the annular deck with deck members retracted;

FIG. 7b is a plan view of a central portion of the annular deck with deck members extended; and

FIG. 8 is an enlarged view of a portion of the platform of FIG. 1 showing shoes and corresponding attachment to support members.

### DETAILED DESCRIPTION

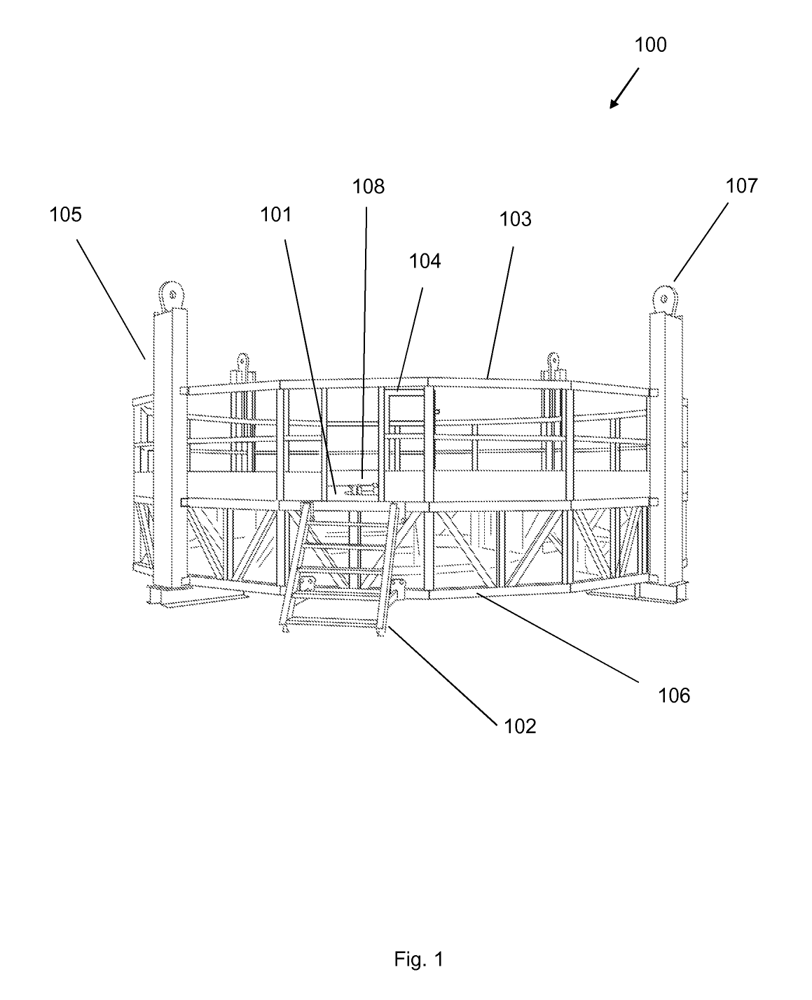

A platform 100 in accordance with the present teaching is shown in FIG. 1 prior to deployment on a chimney or other circular structure. The platform 100 includes an annular deck 101 in which demolition tools and equipment are loaded while the platform 100 sits on the ground. The deck is accessed by a ladder 102 which can be detached for transportation purposes. A safety rail 103 surrounds the deck 101.

A frame 106 is also provided beneath the deck 101. This frame 106 provides structural support to the entire platform. In the preferred embodiment, the platform 100 is divisible into four sections. Specifically, the platform can be disassembled into sections for ease of transport and reassembled at a demolition site prior to deployment. The four sections are held together by brackets 105, which have a dual purpose.

Firstly, they act to provide structural integrity to the platform by joining the four sections together i.e., each bracket joins two sections together. The brackets 105 are detachable from the sections of the platform wherein each bracket is bolted to two corresponding sections of the platform during assembly of the platform.

Secondly, the brackets 105 extend upwards to provide hoist points 107 for lifting of the platform 100 by a crane or any suitable lifting device. Wire ropes or chains are usually attached to the hoist points 107 for lifting.

It should be understood that although the platform of the exemplary embodiment of FIG. 1 is divisible into four sections with four brackets 105 joining these sections, this is not mandatory. The platform 100 could include any number of sections with a corresponding number of brackets 105. Alternatively, the platform could be constructed as a unitary body such that it cannot be disassembled. In such an embodiment the brackets still act to provide structural integrity to the platform and well as providing hoist points 107.

The aforementioned safety rail 103 includes an opening above the ladder 102 for providing access to the deck 101. A hinged (or slidable) gate 104 is further provided for closing of the opening during deployment of the platform. Closing of the gate 104 ensures that the safety rail 103 is continuous around the periphery of the platform 100.

Although not shown in detail in FIG. 1, the platform 100 also includes a circular aperture 108 in the deck 101. This aperture 108 allows the platform to be lowered around a chimney for demolition thereof. As the platform 100 is lowered the chimney passes up through the aperture 108.

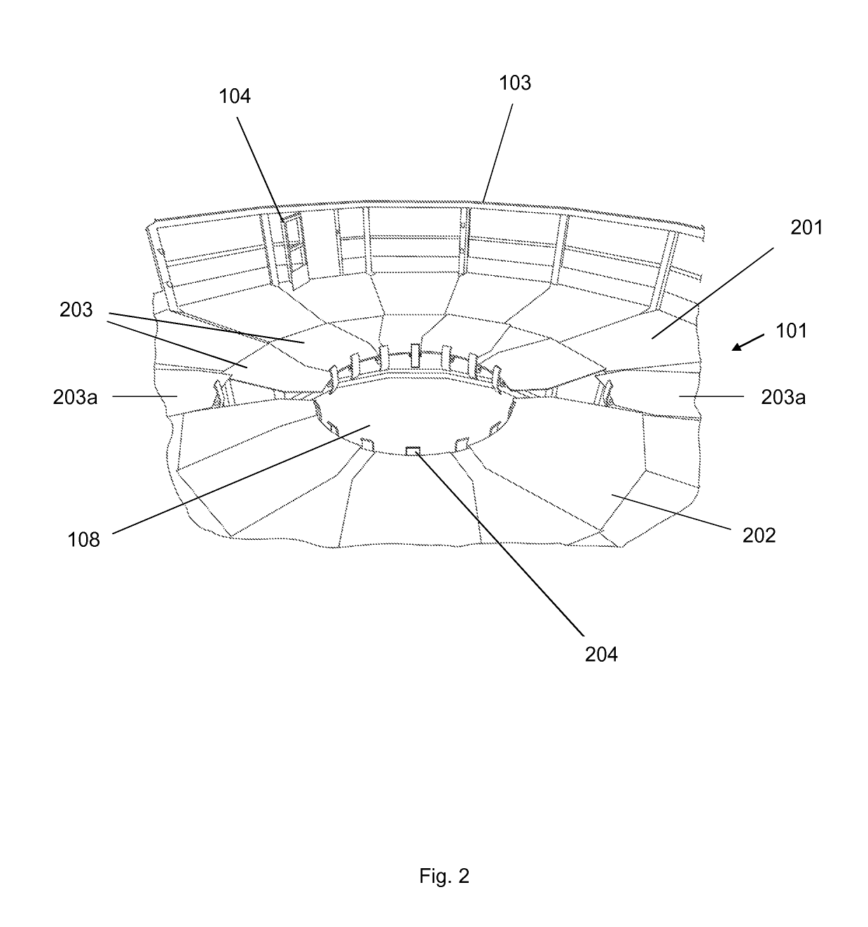

The circular aperture 108 can be seen in more detail in FIG. 2, which provides a perspective view of the deck 101. The same reference numerals are used to describe components or elements already described with reference to FIG. 1. FIG. 2 also illustrates the aforementioned hinged gate 104 and the safety rail 103 in more detail.

As can be seen from FIG. 2, the deck 101 includes an outer annular deck 201 and an inner annular deck 202. The inner annular deck 202 comprises a plurality of deck members 203 wherein each deck member 203 comprises a deck panel mounted to a radial support member (not shown) underneath the deck panel. Each support member is slidable between a first state in which said deck member extends towards the centre of said platform and a second state in which said deck member is retracted towards the periphery of said platform 100. The capability to slide between the first state and second state allows each deck member 203 to be retracted as the platform 100 is lowered around a chimney. In general the deck members are caused to slide towards the periphery of the platform 100 by interaction of each deck member or support member with the external surface of a chimney.

In FIG. 2, two deck members 203a are shown in the second state i.e., fully retracted towards the periphery of the platform. The remaining deck members 203 are in the first state i.e., fully extended towards the centre of the platform 100. It will be appreciated that deck members 203a are simply retracted to show the extent of retraction possible. In use each deck member 203 preferably retracts by the same distance upon contact with the external surface of a chimney. It can be further appreciated that retraction of the deck members 203 increases the diameter of the aperture 108, the minimum diameter of the aperture being when the deck members are fully extended and the maximum diameter being when the deck members are fully retracted. Therefore the platform 100 is capable of being lowered around any chimney having a diameter greater than or equal to said minimum diameter but less than or equal to the maximum diameter of the opening 108.

It can also be seen from FIG. 2 that the deck panels overlap or underlay each other to provide a continuous annular deck portion of varying inner diameter (diameter of aperture 108) as the support members are displaced when moving between the first state and the second state. In addition, each radial support member includes a curved shoe 204 attached to an end closest to the centre of the platform. The shoes 204 are suitably shaped for engagement with the external surface of a chimney as will be described in more detail below.

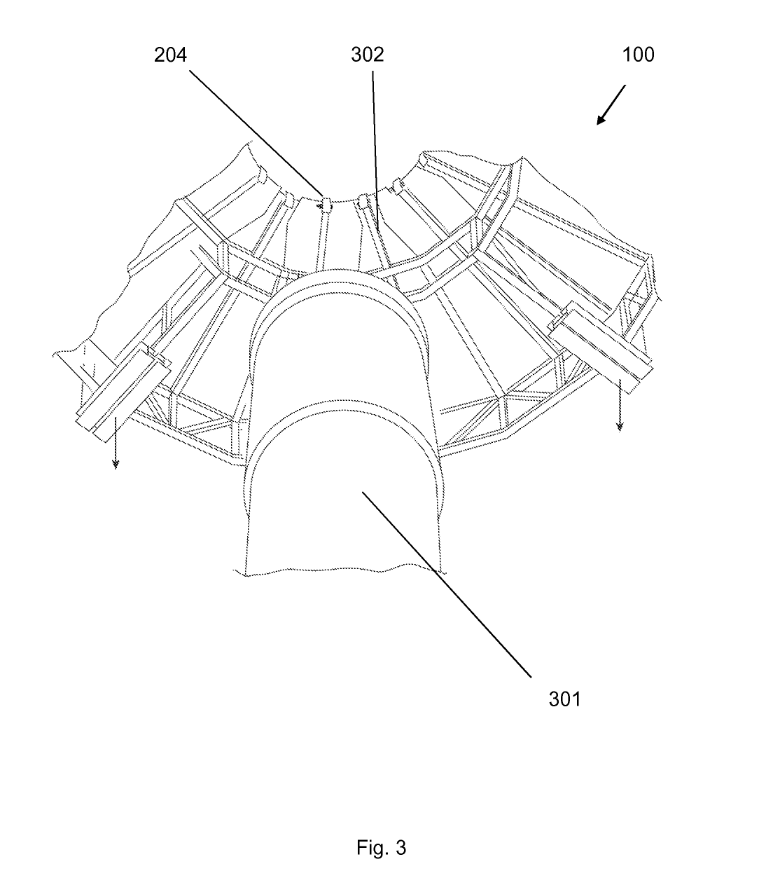

FIG. 3 shows an enlarged view of a portion of the platform 100 as it is being lowered above a chimney 301. The direction of movement is indicated by the arrows in FIG. 3. The same reference numerals are used to describe components or elements already described with reference to the previous figures. It can be appreciated that the underside of platform 100 is illustrated such that the previously mentioned support members are now visible as indicated by reference numeral 302. A shoe 204 at the end of each support member 302 is also shown.

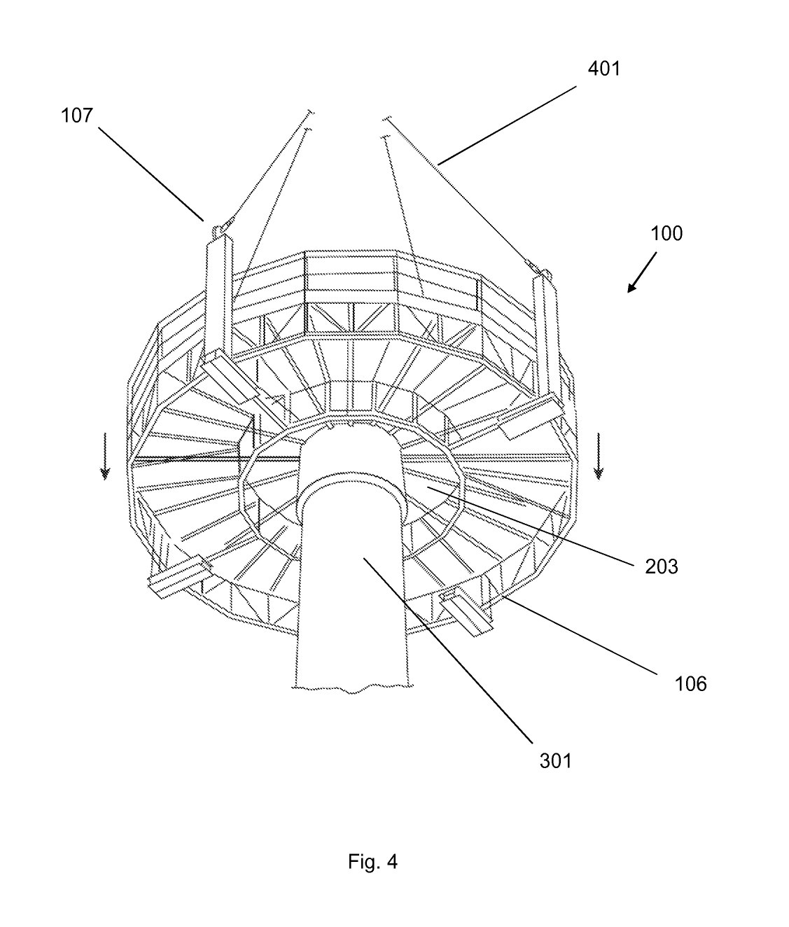

FIG. 4 is a perspective view of the platform 100 after it is lowered around chimney 301. Previously mentioned wire ropes 401 can be seen attached to hoist points 107. Although not shown, an upper end of each wire rope 401 is preferably attached to a crane for lowering of the platform 100 as well as for holding the platform 100 at a stationary position during demolition of the chimney 301. It can be appreciated that the platform, in particular the deck members 203, maintain a close fit to the external surface of the chimney 301.

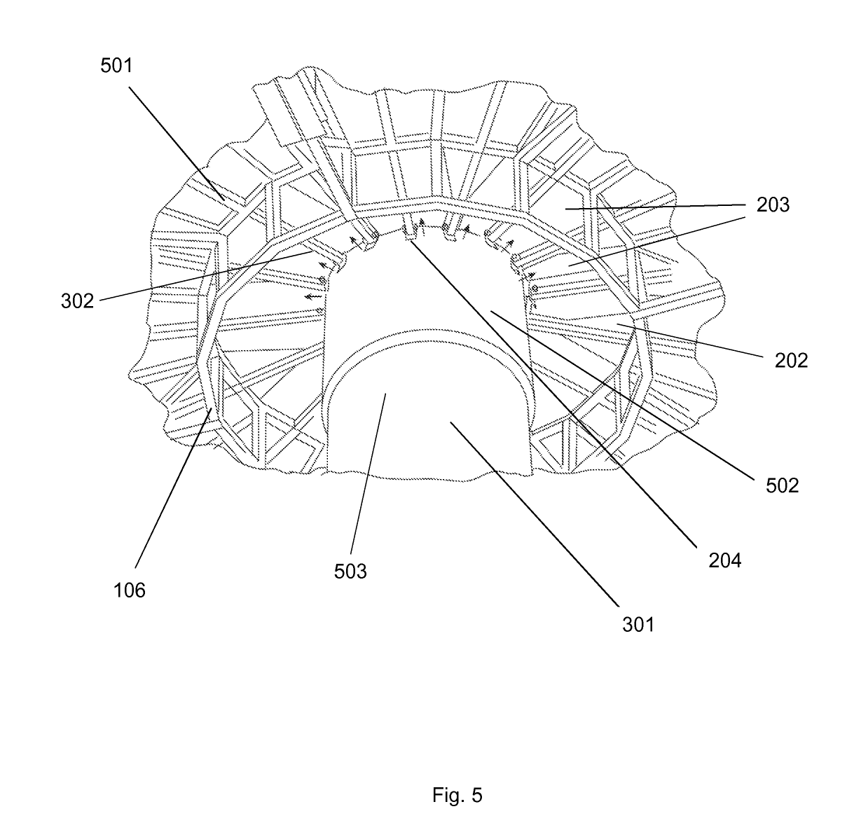

FIG. 5 shows an enlarged view of the inner annular deck 202 of the platform 100 as viewed from underneath. The arrows indicate the direction of movement of the support members 302 as they retract towards the periphery of the platform. A previously mentioned, contact between the shoes 204 and the surface of the chimney 301 forces the support members 302 as well as corresponding deck members 203 in the direction of the arrows. Preferably the platform is centrally aligned with the chimney 301 such that the amount of retraction is substantially equal for each support member 302. The retraction of the support members is possible because the support members are allowed to slide into the frame 106. Specifically, each support member 302 retracts or slides into a corresponding housing member 501. As can be appreciated from FIG. 5, the housing members 501 are integrally formed with the frame 106.

In the context of the present teaching, the support members 302 are also capable of extending towards the centre of the platform i.e., the direction of the chimney. This essentially involves the support members 302 sliding within housing members 501 in a direction opposite to the arrows of FIG. 5. As will be appreciated by those skilled in the art and explained further below, a plurality of methods or mechanisms are possible for affecting the support members 302 to slide towards the centre of the platform i.e., towards the exterior of the chimney.

The ability of each support member 302 with corresponding deck member 203 to extend and retract is particularly advantageous. For example, it can be appreciated from FIG. 5 that the chimney 301 includes an upper annular section 502 with a larger diameter than a lower annular section 503. When the platform is lowered by a crane to the lower section 503, the diameter defined by the inner annular deck 202 is greater than the diameter of the lower section 503. Without adjustment of the diameter defined by the deck, an undesirable gap would form between the external surface of the chimney and the platform. Such a gap would allow debris and equipment to fall through. The platform would also be free to sway while elevated by the crane and could potentially impact the chimney 106 causing damage to the chimney and/or platform.

However, by applying a force to the support members 302 in the direction of the chimney as the platform is lowered, constant contact can be maintained with the surface of the chimney. Specifically the shoes 204 at an inner end of the support members 302 can maintain contact with surface of the chimney 301. It will be understood that the force applied to the support members 302 must be chosen appropriately. Too much force and the platform will not slide down the surface of the chimney as the crane is lowered. Too little force and it is possible that a gap opens between the chimney and the inner annular deck 202.

A further advantage of the ability to dynamically extend and retract the support member is shown as the platform transitions from the wider upper section 502 to the narrower lower section 503. The diameter defined by the inner annular deck 202 can be quickly adjusted (reduced) to close any gap that might start to appear as the platform moves to the narrower lower section 503.

In the context of the present teaching, it will be appreciated that the preferred method of operation of the platform ensures contact is maintained between the shoes 204 and the chimney 301 at all times. As the platform is lowered, the shoes slide down the external surface of the chimney 301. As previously mentioned the shoes are suitable shaped to allow such sliding.

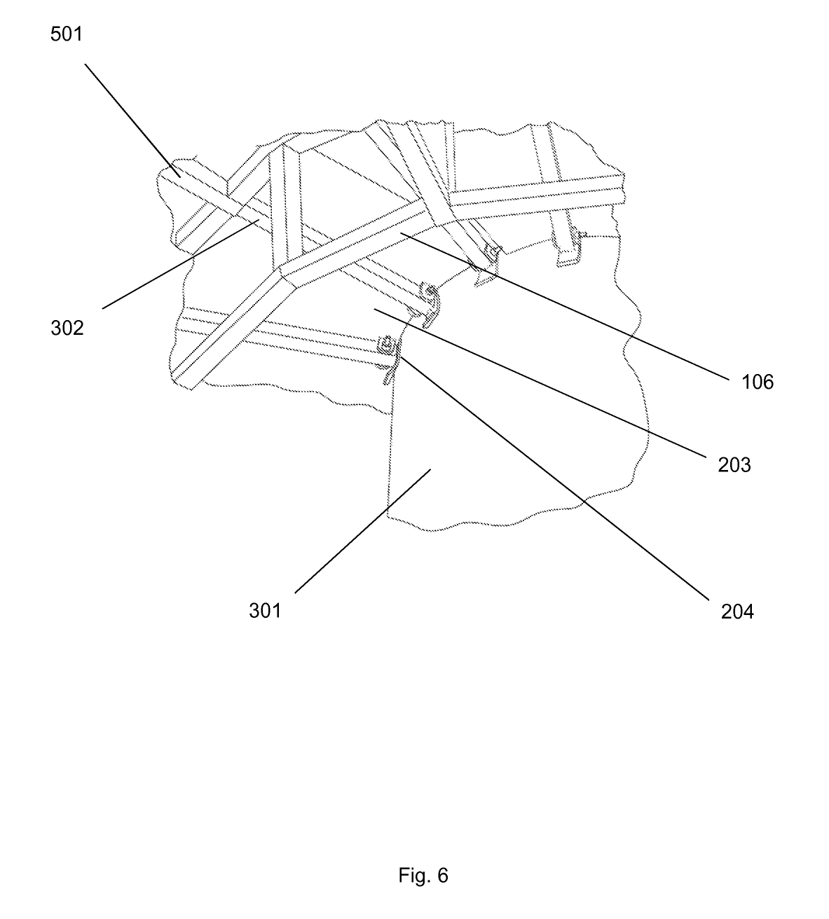

FIG. 6 shows an enlarged view of a portion of FIG. 5. The same reference numerals are used to describe components or elements already described with reference to the previous figures. In particular, the interaction between the support member 302 and the housing member 501 can be more clearly viewed in this figure. That is, the capability of the support member 302 to slide into or within a corresponding housing member 501 is evident. Shoes 204, each maintaining contact with the chimney can also be appreciated.

It should be further understood from the figures that the frame 106 is integrally formed with the outer annular deck 201 such that the inner annular deck is capable of essentially retracting into the area of the outer annular deck. Specifically, the support members 302 retract into the housing members 501 while deck panels of the deck members 203 slide on top the outer annular deck. Each housing member 501 is an integral component of the frame 106 and functions both to allow retraction of the support member 302 and to provide overall structural support to the platform. As illustrated in a number of the figures, the frame 106 is annular and positioned underneath the outer annular deck.

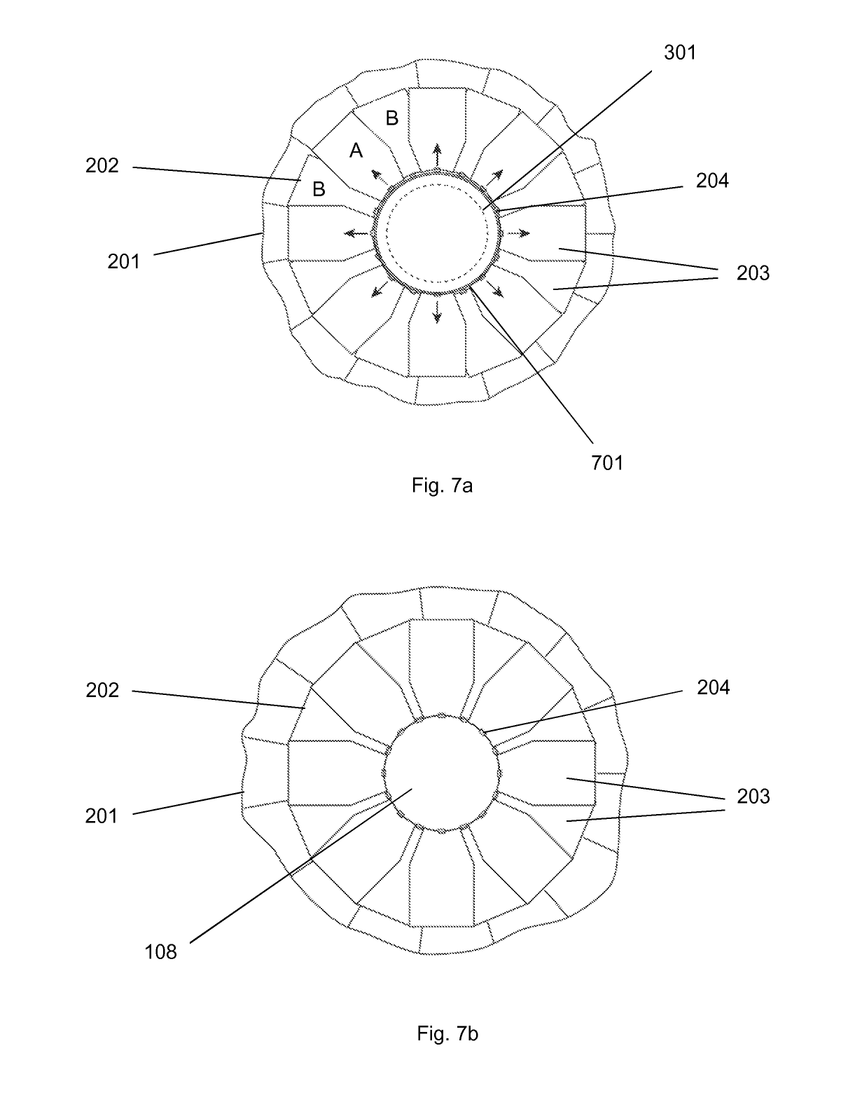

Turning to FIG. 7a, this provides a plan view of a central portion of the annular deck with the deck members 203 in a retracted position as indicated by the arrows. The deck members are shown with maximum retraction such that the chimney 301 is visible underneath the platform. The chimney is identifiable as having a diameter less than that of circular aperture 108. Such a configuration for the platform can be usually adopted prior to lowering the platform to the top of the chimney 301.

The ability of the deck members 203 of the inner annular deck 202 to slide over the outer annular deck 201 should be appreciated from FIG. 7a such that the total area of the deck is reduced when the deck members 203 are retracted. The panels of the deck members are arranged such that alternate deck panels overlap two deck panels. For example, deck panel A overlaps two deck panels B, which are positioned at either side of deck panel A. It should be appreciated that all deck members (with corresponding deck panels) are extended or retracted for adjustment of the diameter of the circular aperture 108. The retraction results in the deck panels A, B etc sliding on top of the outer annular deck 201. As will be explained in more detail later, the deck panels A, B are each hinged at only one point towards the centre of the platform. The weight of each panel is relied upon to maintain a planar area for the deck. Although the outer annular deck 201 is also shown with a panel configuration, these panels are stationary and are affixed to the previously described frame. Furthermore, it is not required that the outer annular deck include panels as shown in FIGS. 7a and 7b. All that is required is a planar deck surface, which allows the panels of the inner annular deck 202 to slide thereon. In addition, the deck surface should be sufficient to support the weight of tools, equipment and workers etc.

In the embodiment shown in FIGS. 7a and 7b, the inner annular deck 202 comprising a total of sixteen sliding deck members 203. However, the present teachings are not limited to such a configuration. Especially in chimneys of very large diameter, it may be advantageous to work with a larger number of sliding deck members 203.

As previously mentioned, the deck members 203 are usually forced to retract as a result of interaction with the external surface of the chimney 301. Prior to deployment, the deck members can also be retracted manually.

There are a number of techniques possible for extending of the deck members 203/radial support members 302. The simplest technique is to use a hand operated ratchet system such that a wire rope or chain is wrapped around the shoes 204 attached to the end of each support member 302. Such a wire rope or chain is indicated by reference numeral 701 in FIG. 7a. A ratchet (not shown) can then be worked to tighten the wire rope 701 in order to affect a force in a direction opposite to that shown by the arrows of FIG. 7a. It can be understood that once the platform is lowered into place, the ratchet can be worked to reduce the diameter of the aperture 108 until the inner annular deck 202 has closed tightly around the chimney. A motor driven ratchet or winch could also be used in place of the hand ratchet.

When it is desired to drop the platform from a first position around the chimney to a second lower position the ratchet is released. The preferred drop step is about 50 or 60 cm. However, it will be appreciated that any reduction step can be taken. In practice, the dropping of the platform is done before demolition reaches the same level as the deck 101. It is preferably to maintain a portion of the chimney above the height of the deck 101 during demolition for safety reasons. As the platform is lowered, the deck members retract as a result of interaction with the chimney. As previously explained, chimneys are usually of conical configuration. Therefore, the diameter of chimney increases as one moves down from the top. Once the platform has been lowered to the desired second position, the ratchet is again worked to affect a force to hold the deck members 203 tightly against the chimney. It will be appreciated that even if the support members 302 are displaced non-uniformly as the platform is lowered, tightening the rope 701 will tend to re-centre the platform about the chimney.

Although not shown, it is also possible to use an hydraulic system to affect a force to extend the deck members. For example, an hydraulic ram could be provided to drive one or more support members 302 relative to their respective support housings 501—see FIG. 6. One of the ram could be mounted on the housing member 501 and the other end mounted on the support member 302. Activation of the hydraulic ram would force the support member to extend in the direction of the chimney 301. For lowering of the platform, the force applied by the hydraulic rams could be reduced to allow the platform (specifically the shoes 204) to slide down the surface of the chimney 301. Alternatively or in addition, springs or other mechanisms could be used to drive the support members relative to their respective housings. However, with the illustrated embodiment, before transport, the support members can be removed from the frame and stacked for ease of transport of both the platform components and support members.

In the illustrated embodiment, tightening the wire rope or chain is not sufficient to friction mount the platform on the chimney and the crane is still relied upon for bearing most of the weight of the platform. However, the platform could be modified, perhaps to add a second set of extendable/retractable support members at a second position on the platform to maintain the platform in place without the need for a crane. The second set of extendable/retractable support members should be positioned below the annular deck 101.

FIG. 7b is a plan view of a central portion of the annular deck with the deck members 203 in an extended position. When compared to FIG. 7a, it can be seen that the deck members have moved inwards to reduce the diameter of the aperture 108. The chimney 301 is no longer visible due to the reduced diameter of the circular aperture 108. The total area of the deck has also increased since the deck panels of the inner annular deck 202 are overlaying a smaller area of the outer annular deck 201. A wire rope or chain around the shoes 204 as illustrated in FIG. 7a is not shown in FIG. 7b.

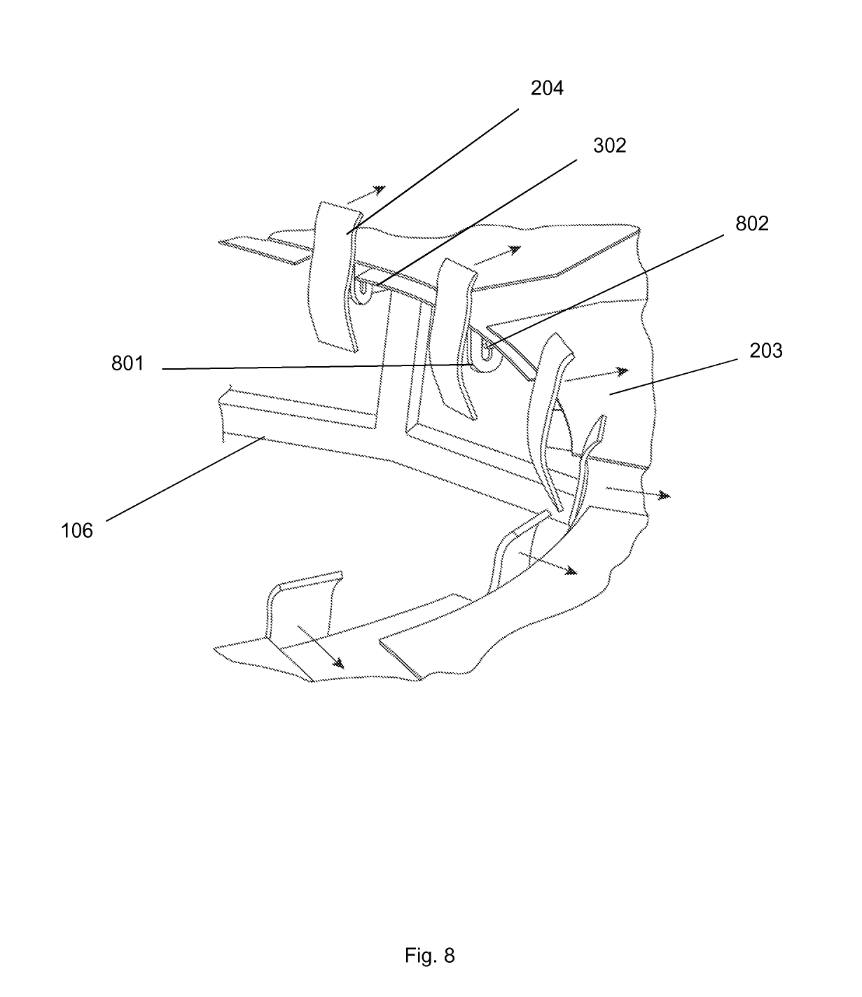

Turning to FIG. 8, this provides an enlarged view of a portion of the platform 100 of FIG. 1 showing shoes 204 and corresponding attachment to support members 302. As indicated by the arrows, the deck members 203 are shown in a retracted position such that the frame 106 is visible. As will be appreciated the same reference numerals are used to describe components or elements already described with reference to the previous figures.

In this figure, each deck panel of a deck member 203 is mounted to a corresponding radial support member 302 at a single point using a hinge 801. In the illustrated embodiment, this hinge is the only means of attachment for the deck panels. It can be appreciated that the previously described underlaying and overlapping arrangement of the panels ensures that a planar surface is maintained as the support members 302 are extended and retracted. In addition, as each of the deck panels are metal panels of significant weight, this also ensures that the panels do not easily lift up during retraction and extension.

Each hinge 801 comprises a substantially U-shaped bracket integrally formed with a deck member 203 wherein a corresponding support member 302 is bolted between each arm of the U-shaped bracket. A bolt 802 passes through the entire width of the support member 302 to connect the U-shaped bracket of the hinge 801 to the support member 302. This configuration can also be viewed from underneath in FIG. 6 wherein it can be seen that the U-shaped bracket is essentially an inverted U-shaped bracket with the support member held within the U-shaped bracket.

Each hinge 801 further allows movement of a corresponding deck portion in a vertical direction. This is a result of each arm of the U-shaped bracket having an elongated opening (elongated in the vertical direction) such that the bolt held therein is free to move in a vertical direction. In addition, the elongated opening of the bracket allows an easier attachment of the deck panel to the support member 302 in that perfect alignment of two circular holes does not have to be achieved in order to pass the bolt there through.

Alternatively, pins could be used in place of bolts or any suitable attachment means could be provided.

It can be further appreciated from FIG. 8 that each shoe 204 is vertically orientated when a corresponding support member 302 is horizontally orientated. Each shoe curves towards the periphery of the platform i.e., in the direction of the arrows of FIG. 8. Specifically, each shoe 204 has two ends which both curve towards the periphery of the platform. Each shoe further extends above and below the surface of the inner annular deck such.

The shape of the shoes 204 allows the platform to slide smoothly down the surface of the chimney as the platform is lowered by a crane. As shown in FIGS. 6 and 8 each shoe 204 is integrally formed with a respective support member. However, the shoes could also be detachable and independently hinged. For example, a second hinge could be provided for each support member that would allow a respective shoe attached thereto to tilt back and forth i.e., away from and towards the centre of the platform.

As previously mentioned the platform can be disassembled into four sections for ease of transport and reassembled at a demolition site prior to deployment. The ability to disassemble the platform 100 into sections is particularly advantageous. The first step of disassembling the platform is to remove each deck members (including deck panels and support members). This is done by simply extending the support members towards the centre of the platform until they are no longer held by the housing members 501. Each of the brackets 105 is then unbolted and detached from the platform. A first section of the platform is then inverted and placed on a second section that is not inverted. The placement of the first section on the second section involves the face of the outer annular deck 201 of each of the first and second section coming into contact with each other. The first and second sections are then strapped or held together to form a modular unit for transport.

It will be appreciated that the same procedure is carried out for the third and fourth sections such that two modular units, each containing two sections, are produced for transport. This procedure for disassembly enables the complete platform to be transported on a single articulated lorry. Moreover, it is made possible by the configuration of the platform outlined above.

While the platform has been described for demolition purposes, the platform should not be considered as limited to such use and it could also be used for affecting repairs of chimneys or any circular structure. Specifically the platform provides a stable work platform from which a variety of tasks can be carried out. It will be appreciated that where the platform is lowered over a chimney for maintenance purposes, a further frame (not shown) will need to be located above the platform to ensure the ropes 401 are maintained spaced apart from the chimney. In addition, padding is preferably provided around each shoe 204 to prevent any damage to the chimney or circular structure when the support members 302 are extended to clamp around the chimney.

The words comprises/comprising when used in this specification are to specify the presence of stated features, integers, steps or components but does not preclude the presence or addition of one or more other features, integers, steps, components or groups thereof.

What is claimed is:

1. A platform comprising a frame supporting an outer annular deck and an inner annular deck, wherein the inner annular deck comprises a plurality of deck members, each deck member comprising a deck panel mounted to a radial support member, each support member being slidable between a first state in which said deck member extends towards the centre of said platform and a second state in which said deck member is retracted towards the periphery of said platform, said deck panels overlapping each other to provide a continuous annular deck portion of varying inner diameter as said support members are displaced when moving between said first state and said second state.

2. The platform of claim 1 wherein each radial support member comprises a curved shoe at an end closest to the centre of said platform.

3. The platform of claim 2 wherein the force applied to each shoe from the direction of the centre of the platform causes the corresponding support member to retract towards the periphery of said platform.

4. The platform of claim 2 wherein each shoe is vertically orientated when the support member is horizontally orientated.

5. The platform of claim 2 wherein each shoe curves towards the periphery of said platform.

6. The platform of claim 2 wherein each shoe has two ends which both curve towards the periphery of said platform.

7. The platform of claim 2 wherein each shoe is integrally formed with a respective support member.

8. The platform of claim 2 wherein each shoe extends above the surface of the inner annular deck.

9. The platform of claim 1 where the outer annular deck further comprises a safety rail at the periphery of said platform.

10. The platform of claim 1 wherein each support member is slidable in a housing member between the first state and the second state.

11. The platform of claim 10 wherein each housing member is an integral component of the frame.

12. The platform of claim 1 wherein the frame is annular and positioned underneath the outer annular deck.

13. The platform of claim 1 wherein the frame is integrally formed with the outer annular deck.

14. The platform of claim 13 wherein the frame integrally formed with the outer annular deck comprises a plurality of sections.

15. The platform of claim 14 further comprising a bracket for each of the plurality of sections, each bracket holding two adjacent sections together.

16. The platform of claim 1 wherein each deck panel is mounted to a corresponding radial support member at a single point using a hinge.

17. The platform of claim 16 wherein each hinge comprises a substantially U-shaped bracket integrally formed with a deck member wherein a corresponding support member is bolted between each arm of the bracket.

18. The platform of claim 17 wherein each hinge allows movement of a corresponding deck portion in a vertical direction.
